(19) United States
(12) Patent Application Publication
(10) Pub. No.: US 2008/0237353 A1
(43) Pub. Date: Oct. 2, 2008

(54) Unique identifier on integrated circuit device

(76) Inventors: Joy Lau, Chandler, AZ (US); Wen-Kai Mike Tsai, Gilbert, AZ (US); Sohrab Mogharrabi, Chandler, AZ (US)

Correspondence Address: CAVEN & AGHEVLI;c/o INTELLEVATE, LLC, P.O. BOX 52050, MINNEAPOLIS, MN, 55402, US

(21) Appl. No.: 11/729,643

(22) Filed: Mar. 29, 2007

(51) Int. Cl. G06K 19/00

(52) U.S. Cl. 235/487; 101/32

(57) ABSTRACT

Methods and apparatus relating to use and/or provision of a unique identifier on an integrated circuit (IC) device are described. In one embodiment, an indicia may be provided on a substrate to uniquely identify the substrate. In an embodiment, the indicia may be used to track the substrate. Other embodiments are also described.

### BACKGROUND

The present disclosure generally relates to the field of electronics. More particularly, an embodiment of the invention relates to provision of a unique identifier on an integrated circuit (IC) device.

An IC device may include various markings thereon, for example, to identify the manufacturer or device model number. As IC devices become smaller, however, provision of such markings becomes problematic, e.g., due to the area that the markings may consume on IC devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-3 illustrate views of portions of semiconductor devices, according to some embodiments.

FIG. 4 illustrates a block diagram of a method according to an embodiment.

FIG. 5 illustrates a block diagram of a marking system, according to an embodiment of the invention.

FIG. 6 illustrates a block diagram of a computing system, which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

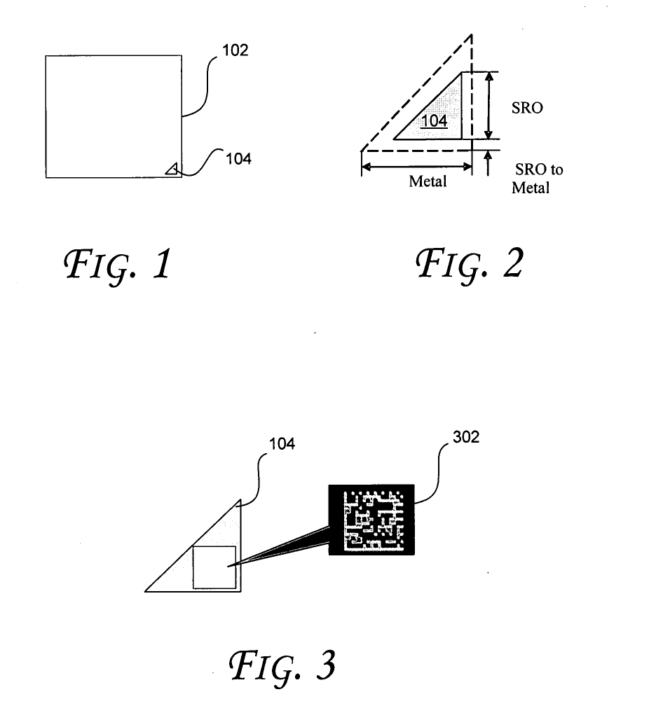

Some of the embodiments discussed herein (e.g., with reference to FIGS. 1-6) may provide and/or utilize an indicia (such as a matrix mark) on an IC device. However, the techniques described herein may be used to provide and/or utilize an indicia on any type of substrate (whether a semiconductor substrate or another type of a substrate). In one embodiment, a laser beam (e.g., a green laser beam) may be used to provide the indicia within a fiducial (e.g., on pin one fiducial) of an IC device. Furthermore, as discussed herein, an indicia within a fiducial is intended to also interchangeably refer to an indicia provided on and/or inside a fiducial. In an embodiment, the indicia may be used to enable unique identification of a given IC device. For example, the device may be traced based on the indicia during manufacturing or after the device is put into use (e.g., due to a failure, reclamation, etc.). In one embodiment, the progress of an IC device through the manufacturing process may be tracked, e.g., by storing information regarding the processing of the device (for example, indicating that the device was processed by a given operator, a certain equipment, at a specific time, under certain conditions, by utilizing certain material, etc.). Such information may be used to determine points of failure in the manufacturing process in some embodiments.

FIGS. 1-3 illustrate views of portions of semiconductor devices, according to some embodiments. Referring to FIG. 1, the substrate 102 is shown with a fiducial 104. In some embodiments, the substrate 102 may be a semiconductor package. In one embodiment, the fiducial 104 may be the pin one fiducial that may be provided in some IC devices, e.g., which may be used to locate and/or orient the IC devices during manufacturing. In some embodiments, the fiducial 104 may have a triangular shape (such as shown in FIG. 1). Also, the fiducial 104 may be gold-plated in some embodiments. As shown in FIG. 2, dimensions of the fiducial 104 may correspond to solder resist opening (SRO) and metal present on the substrate 102 in an embodiment.

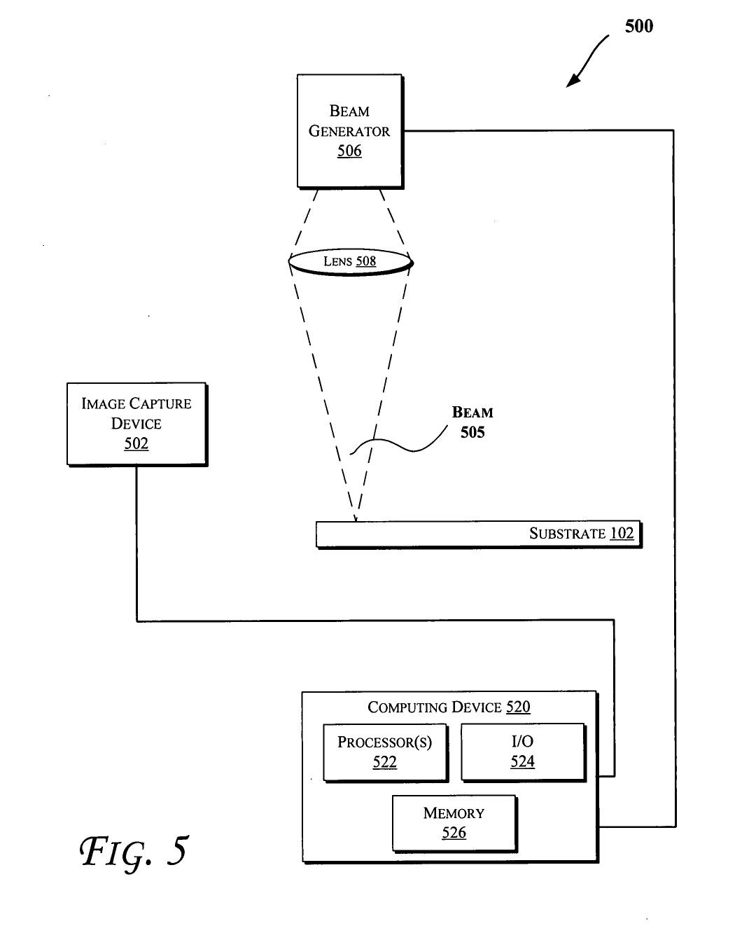

Referring to FIG. 3, the fiducial 104 is shown with a two-dimensional (2-D) matrix 302, e.g., provided within the boundaries of the fiducial 104, according to an embodiment of the invention. Other types and/or shapes of a 2-D matrix may also be utilized in some embodiments of the present invention. In an embodiment, the 2-D matrix 302 may be provided by utilizing a green laser beam 505 of FIG. 5. Other types of indicia (such as 2-D matrix, human readable, machine readable, text and/or barcode) may also be provided on the fiducial 104 in some embodiments.

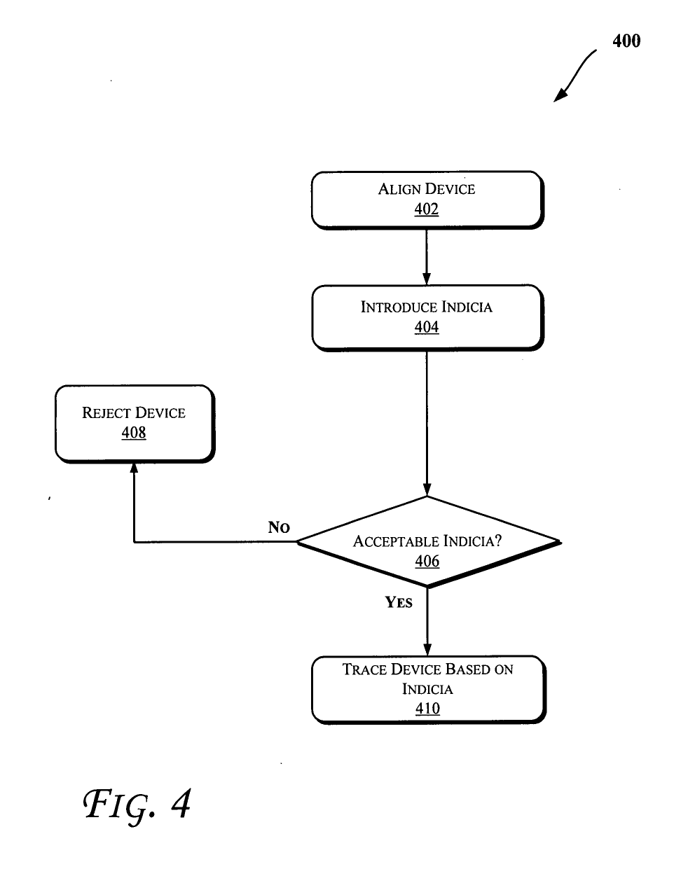

FIG. 4 illustrates a block diagram of an embodiment of a method 400 to mark and/or trace a device. In an embodiment, various components discussed with reference to FIGS. 1-3 and 5-6 may be utilized to perform one or more of the operations discussed with reference to FIG. 4. For example, the method 400 may be used to mark and/or trace the substrate 102 of FIGS. 1-3.

Referring to FIGS. 1-4, at an operation 402, an IC device may be aligned (e.g., for marking as will be further discussed herein with reference to FIG. 5). At an operation 404, an indicia may be introduced on the IC device (e.g., an indicia, such as the 2-D matrix 302, may be introduced on the fiducial 104). At operation 406, it may be determined whether the indicia introduced at operation 404 is acceptable. For example, the image capture device 502 of FIG. 5 may be used to capture images of the substrate 102 (e.g., and more specifically of the indicia) to determine whether the introduced indicia is acceptable (e.g. readable). If the indicia is not acceptable, the device may be scrapped as a reject in operation 408. Otherwise, the indicia may be used to trace the device at operation 410.

FIG. 5 illustrates a block diagram of a system 500 that may be used for mark substrates, in accordance with some embodiments of the invention. As shown in FIG. 5, the system 500 may include an image capture device 502, e.g., to capture one or more images of the substrate 102. The device 502 may capture an image of the substrate 102 after (or while) a beam 505 (e.g., generated by a beam generator 506) is used to mark (e.g., to introduce the indicia discussed with reference to FIGS. 1-4, for example) the substrate 102.

In an embodiment, the generator 506 may be any type of an electromagnetic beam generator such as a green laser source capable of producing an optical pulse train. Other types of a laser source may also be utilized. Additionally, the system 500 may optionally include a lens 508 to focus the beam generated by the beam generator 506. Also, the lens 508 may include more than a single lens in some embodiments.

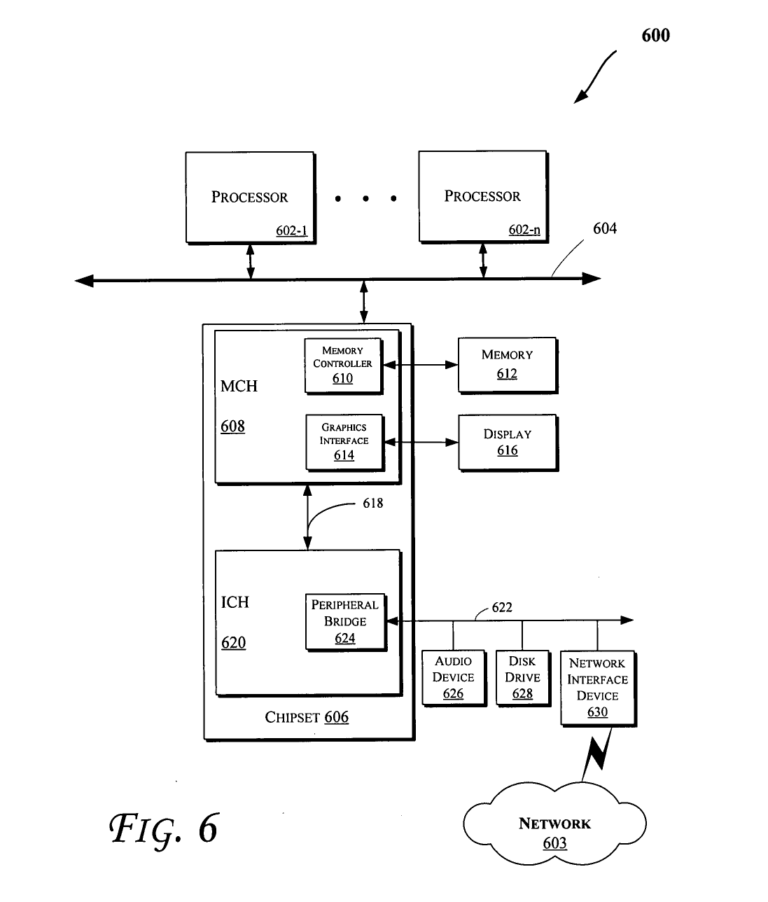

As illustrated in FIG. 5, the system 500 may additionally include a computing device 520, e.g., to control some or all of the operations performed by the system 500, as discussed herein, for example, with reference to FIG. 4. For example, in an embodiment, at operation 402 of FIG. 4, an actuator (not shown) may move the substrate 102 and/or align it based on the fiducial 104 (e.g., at the direction of the computing device 520). Alternatively, a general-purpose computing device (such as the computing system 600 discussed with reference to FIG. 6) may be used instead of or in addition to the computing device 520, e.g., to control some or all of the operations performed by the system 500 and/or to perform analysis regarding the indicia present on the substrate 102 (e.g., such as discussed with reference to operation 406 of FIG. 4).

Moreover, the computing device 520 may include one or more processors 522, an input/output (I/O) module 524, and/or a memory 526 (which may be a volatile and/or nonvolatile memory). For example, the I/O module 524 may communicate with various components of the system 500, while the processors 522 may process the communicated data and the memory 526 may store the communicated data. As shown in FIG. 5, the computing device 520 may control and/or communicate with the beam generator 506 and/or the image capture device 502. For example, the computing device 520 may cause the beam generator 506 to generate a beam at a select energy, wavelength, frequency, for a certain time period, etc. Moreover, the computing device 520 may cause the image capture device 502 to capture an image of the substrate 102 for further processing in some embodiments (e.g., such as discussed with reference to operation 406 of FIG. 4).

In some embodiments, at operation 404, one or more of the characteristics of the beam 505 (e.g., beam intensity, wavelength, duration, repetition rate, etc.) may be adjusted, e.g., based on the thickness and/or surface characteristics (e.g., mirror finish or brushed finish) of the substrate 102 and/or fiducial 104. For example, an operator may provide the thickness and/or surface characteristics of the substrate 102 and/or fiducial 104 to the system 500 to cause adjustments (e.g., beam intensity, wavelength, duration, repetition rate, etc.) to the beam 505. Alternatively, one or more of the characteristics of the beam 505 (e.g., beam intensity, wavelength, duration, repetition rate, etc.) may be adjusted at the direction of a computing device (e.g., device 520 and/or system 600 of FIG. 6). For example, one or more images captured by the image capture device 502 may be analyzed by the computing device or system to determine if and how to modify one or more characteristics of the beam 505.

FIG. 6 illustrates a block diagram of a computing system 600 in accordance with an embodiment of the invention. In an embodiment, various IC components of the system 600 may be marked such as discussed with reference to FIGS. 1-5. Also, the system 600 may be used to control various components of FIG. 5 such as the image capture device 502, beam generator 506, lens 508, etc. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. Moreover, the operations discussed with reference to FIGS. 1-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612. The memory 612 may store data, including sequences of instructions that are executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display 616. In one embodiment of the invention, the graphics interface 614 may communicate with the display 616 via an accelerated graphics port (AGP). In an embodiment of the invention, the display 616 may be a flat panel display that communicates with the graphics interface 614 through, for example, a signal converter that translates a digital representation of an image stored in a storage device such as video memory or system memory into display signals that are interpreted and displayed by the display 616. The display signals produced by the interface 614 may pass through various control devices before being interpreted by and subsequently displayed on the display 616.

A hub interface 618 may allow the MCH 608 and an input/output control hub (ICH) 620 to communicate. The ICH 620 may provide an interface to I/O devices that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and the MCH 608 may be combined to form a single chip. Furthermore, the graphics interface 614 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 600 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 5-6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
an integrated circuit device substrate having an indicia formed on a fiducial of the integrated circuit device, wherein the indicia is introduced on the fiducial by an electromagnetic radiation beam.

2. The apparatus of claim 1, wherein the electromagnetic radiation beam comprises a laser beam.

3. The apparatus of claim 1, wherein the electromagnetic radiation beam comprises a green laser beam.

4. The apparatus of claim 1, wherein the indicia comprises one or more of a two-dimensional matrix, human readable indicia, machine readable indicia, text based indicia, or barcode

5. The apparatus of claim 1, further comprising logic to adjust one or more characteristics of the electromagnetic radiation beam.

6. The apparatus of claim 5, wherein the logic is to adjust the one or more characteristics based on one or more of a thickness or a surface characteristic of the fiducial.

7. The apparatus of claim 1, further comprising an image capture device to capture one or more images of the fiducial.

8. The apparatus of claim 7, further comprising a computing device coupled to the image capture device.

9. The apparatus of claim 8, wherein the computing device is to cause the image capture device to capture the one or more images of the fiducial.

10. The apparatus of claim 8, wherein the computing device is to analyze the one or more images of the fiducial.

11. The apparatus of claim 1, wherein the device comprises one or more of: a processor, a memory device, a network communication device, or a chipset.

12. A method comprising:
forming an indicia on a fiducial of a substrate, wherein the indicia is introduced on the fiducial by an electromagnetic radiation beam.

13. The method of claim 12, further comprising adjusting one or more characteristics of the electromagnetic radiation beam.

14. The method of claim 13, wherein adjusting the one or more characters is performed based on one or more of a thickness or a surface characteristic of the fiducial.

15. The method of claim 12, further comprising capturing one or more images of the fiducial.
